(19) United States
(12) Patent Application Publication
(10) Pub. No.: US 2013/0018524 A1
(43) Pub. Date: Jan. 17, 2013

(54) Single Handed Attendant Control for a Wheelchair

(71) Applicants: Mark Ankers, Newtown, CT (US); Matthias Holenweg, Buren an der Aare (CH)

(72) Inventors: Mark Ankers, Newtown, CT (US); Matthias Holenweg, Buren an der Aare (CH)

(73) Assignee: Curtis Instruments, Inc.

(21) Appl. No.: 13/546,523

(22) Filed: Jul. 11, 2012

Related U.S. Application Data
(60) Provisional application No. 61/506,229, filed on Jul. 11, 2011.

(51) Int. Cl. G05G 9/047; G05G 1/00; G06F 17/00

(52) U.S. Cl. 701/1; 74/491; 74/471 XY

(57) ABSTRACT

Disclosed herein is a personal mobility vehicle controller. The personal mobility vehicle controller includes a housing having a first input member, a second input member, and a third input member. The first input member is configured to change a mode or profile of a personal mobility vehicle. The second input member is configured to provide a security function for the third input member. The third input member is configured to operate a feature based on the mode or profile. The housing is adapted to be held in a single hand of a user. The personal mobility vehicle controller is configured to operate the personal mobility vehicle with the single hand from a location proximate the personal mobility vehicle.

### CROSS REFERENCE TO RELATED APPLICATION

This application claims priority under 35 U.S.C. §119(e) to U.S. provisional patent application No. 61/506,229 filed Jul. 11, 2011 which is hereby incorporated by reference in its entirety.

### BACKGROUND OF THE INVENTION

1. Field of the Invention

The invention relates to personal mobility vehicles and, more particularly, to a control system for a personal mobility vehicle such as a wheelchair.

2. Brief Description of Prior Developments

Self-powered personal mobility vehicles, such as wheelchairs having a self-contained power source to provide drive power to wheels and steering actuators, may include various systems to control the various power and motive subsystems of the vehicle, as well as to implement a user interface function enabling an occupant of the vehicle to control the overall operation of the vehicle, such as to start, stop and steer the vehicle.

There are certain times when individuals with severe disabilities may not be able to effectively operate their personal mobility vehicle/device. Instances such as maneuvering through very tight areas, entering and exiting a modified vehicle and even general driving can be difficult or impossible at times due to fatigue, illness or a general absence of fine motor skills. In most instances, this is addressed with the use of an “attendant control” feature of the personal mobility vehicle.

A problem that can be presented relates to providing a simple, robust and low cost interface to enable an improved control feature of the personal mobility vehicle.

### SUMMARY OF THE INVENTION

In accordance with one aspect of the invention, a personal mobility vehicle controller is disclosed. The personal mobility vehicle controller includes a housing having a first input member, a second input member, and a third input member. The first input member is configured to change a mode or profile of a personal mobility vehicle. The second input member is configured to provide a security function for the third input member. The third input member is configured to operate a feature based on the mode or profile. The housing is adapted to be held in a single hand of a user. The personal mobility vehicle controller is configured to operate the personal mobility vehicle with the single hand from a location proximate the personal mobility vehicle.

In accordance with another aspect of the invention, a personal mobility vehicle is disclosed. The personal mobility vehicle includes a control unit and a personal mobility vehicle controller connected to the control unit. The control unit includes at least one data processor. The personal mobility vehicle controller includes a housing having a first input member, a second input member, and a third input member. The first input member is configured to change a mode or profile of a personal mobility vehicle. The second input member is configured to enable operation of the third input member. The third input member is configured to operate a feature based on the mode or profile. The housing is adapted to be held in a single hand of a user. The first input member, the second input member, and the third input member are adapted to be operable with the single hand of the user.

In accordance with another aspect of the invention, a method is disclosed. A personal mobility vehicle controller having a housing is provided. A first input member, a second input member, and a third input member are provided on the housing. The third input member is configured to operate a feature of the personal mobility vehicle. The third input member is configured to operate the feature only when the second input member is depressed. The housing is adapted to be held in a single hand of a user.

### BRIEF DESCRIPTION OF THE DRAWINGS

The foregoing aspects and other features of the invention are explained in the following description, taken in connection with the accompanying drawings, wherein:

FIG. 1A is a perspective view of a personal mobility vehicle incorporating features of the invention;

FIG. 1B is a perspective view of a user interface/control portion of the vehicle shown in FIG. 1A;

FIG. 2 is a simplified block diagram of a vehicle system controller of the vehicle shown in FIG. 1A; and

FIG. 3 is a perspective view of another user interface/control portion of the vehicle shown in FIG. 1A.

### DETAILED DESCRIPTION OF THE PREFERRED EMBODIMENT

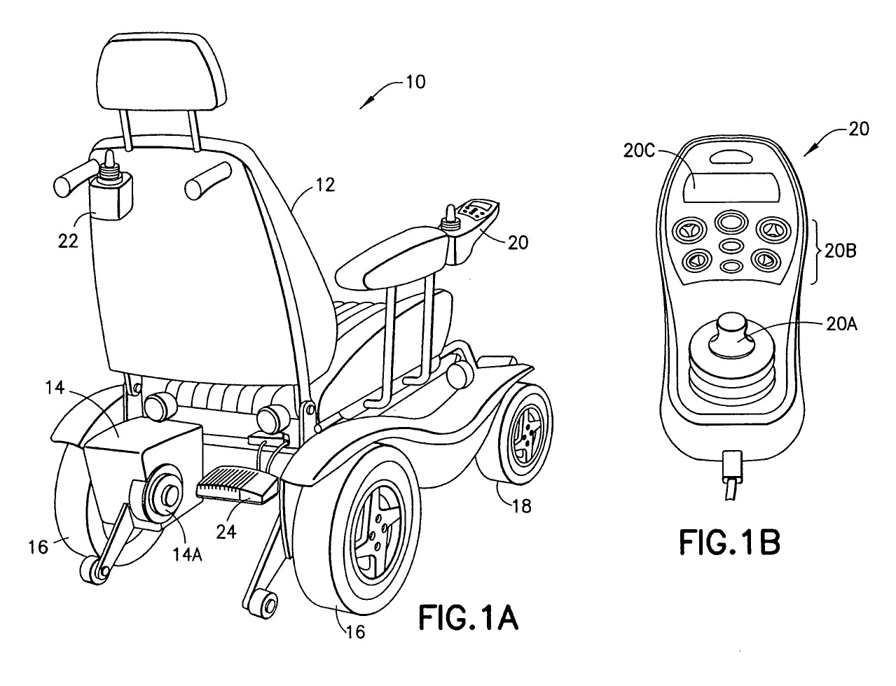

Referring to FIG. 1A, there is shown a perspective view of a personal mobility vehicle 10 incorporating features of the invention. Although the invention will be described with reference to the exemplary embodiment shown in the drawings, it should be understood that the invention can be embodied in many alternate forms of embodiments. In addition, any suitable size, shape or type of elements or materials could be used.

In the embodiment shown in FIG. 1A the personal mobility vehicle is embodied as a wheelchair system 10, although this is not a limitation upon the use and practice of the exemplary embodiments of this invention. As employed herein a wheelchair system is considered as a vehicle that may be capable of controlled, self-powered (e.g., battery powered) movement for a sitting person.

The wheelchair system 10 includes a seat portion 12, a power source 14, such as a battery and related power conversion, conditioning and recharging circuitry, and at least two wheels 16 that are driven by the power source 14 via at least one motor 14A. One or more other wheels 18 provide stability and enable steering of the wheelchair system 10. In this regard there is a user-actuated hand control system (or user interface) 20 that may include a joystick type controller 20A, a plurality of buttons 20B, and a display 20C, such as an LCD, LED or other suitable type of display system (shown in FIG. 1A). The control system 20 operates with a control system of controller (or control unit) 24 to provide functions that include, but need not be limited to, starting and stopping motive power to the drive wheels 16, controlling the direction of rotation and speed of rotation of the drive wheels 16, and controlling a pointing direction of the wheels 18 to provide steering of the wheelchair 10.

The wheelchair system 10 further includes an attendant control system 22. The attendant control (or attendant control system) 22 generally allows for obtaining control of the wheelchair at the rear of the vehicle. For example, the attendant control is generally used by a family member or caregiver to maneuver, drive or reposition the wheelchair. The attendant control system 22 also operates with the control system of the controller 24 to provide functions that include, but need not be limited to, starting and stopping motive power to the drive wheels 16, controlling the direction of rotation and speed of rotation of the drive wheels 16, controlling a pointing direction of the wheels 18 to provide steering of the wheelchair 10, controlling a seat function, and controlling auxiliary functions.

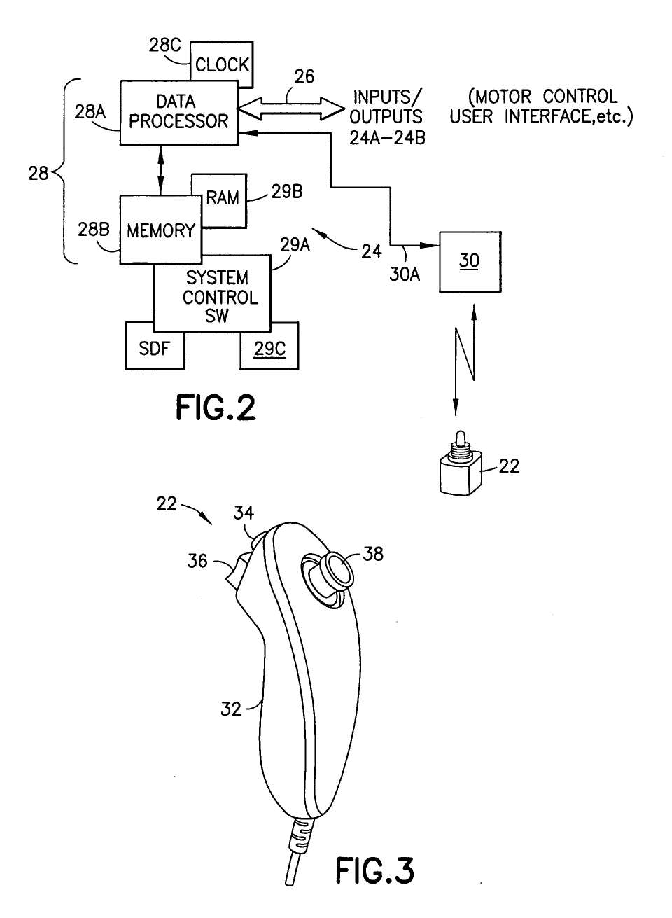

FIG. 2 shows a simplified block diagram of a portion of the controller 24. The controller 24 can be assumed to include a software system 28 that includes at least one data processor 28A, such as a microprocessor or microcontroller, and a memory 28B that stores programs to control operation of the data processor 28A and, thereby, to control the overall operation of the wheelchair 10. The operating programs, also referred to as system control software (SW) 29A, may include firmware, such as computer programs that are permanently stored in, by example, non-volatile read only memory (NV-ROM), or system control SW 29A may be stored in volatile random access memory (RAM) 29B that is loaded from a disk or some other type of memory storage medium. The exemplary embodiments of this invention are also usable with a system where a system control SW 29A is stored in a mass memory device, such as a disk, and loaded into RAM as needed.

The system control SW 29A can include a system diagnostic function or functions (SDF), and to store in the memory diagnostic-related data (e.g., operational logs, failure logs, logs recording operational parameters of the power and drive system, etc.) as diagnostic data 29C.

In some embodiments a separate dedicated processor may be used to implement the diagnostics function, or the diagnostics function may be executed by the data processor 28A.

The data processor 28A is coupled via general use input/output hardware 26 to various input/outputs, including general input/outputs, such as input/outputs 24A going to and from the user-actuated hand control system 20 and inputs/outputs 24B providing control to the motor(s) 14. A clock function or module 28C can be included for maintaining an accurate time of day and calendar function.

According to some embodiments of the invention, the controller 24 can further be connected to a wireless interface (WI) 30, such as a Bluetooth™ interface, for example. However, any suitable type of wireless interface or connection may be provided.

Referring now also to FIG. 3, the attendant control system 22 is shown in greater detail. The attendant control system (or personal mobility vehicle controller) 22 includes a housing 32, a mode button 34, a security switch 36, and a directional switch (or joystick) 38.

The attendant control system 22 provides improvements over conventional configurations by allowing for operation of the personal mobility vehicle 10 with a single hand from any suitable location in proximity to the personal mobility vehicle 10.

Similar to the user-actuated hand control system 20 configuration described above, the data processor 28A is coupled via the general use input/output hardware 26 to the various input/outputs, including the input/outputs 24A also going to and from the attendant control system 22 and the inputs/outputs 24B providing control to the motor(s) 14.

The housing of the attendant control system (or personal mobility vehicle controller) 22 is suitably sized and shaped to fit within a user's hand to allow for single handed (or one handed) operation. For example, the attendant control 22 can comfortably fit within the user's hand wherein a portion of the housing is held in a palm of the hand, the mode button 34 is operable with an index finger of the hand, the security switch 36 is operable with an index finger of the (same) hand, and the joystick 38 is operable with a thumb of the (same) hand. This allows a person assisting a wheelchair user via the attendant control the opportunity of controlling all wheelchair operations with the use of only one hand. For example, the single-handed operation will allow the caregiver to provide additional assistance to the user when needed.

The mode button (or first input member) 34 of the attendant control system (or personal mobility vehicle controller) 22 may comprise any suitable type of button or switch and is connected to the housing. The mode button 34 is suitably located on the housing such that a user can operate the mode button 34 with a finger of the hand holding the attendant control system. The mode button 34 is configured to change between different modes or profiles of a personal mobility vehicle. The different modes or profiles can include functions such as, but not limited to, drive functions, seat (or seat position) functions, or auxiliary functions.

For example, in one embodiment of the invention, profile 1 can be a “slow drive” function, profile 2 can be a “fast drive” function, profile 3 can be a “seat” or “seat position” function, and profile 4 can be an “auxiliary” function. In this way, by pressing mode button 34 once, the system changes from profile 1 to profile 2, or from profile 2 to profile 3, and so forth. However, it should be noted that any suitable number or combination of profiles may be provided.

While examples of the invention have been described in connection with the first input member 34 provided as a button, one skilled in the art will appreciate that examples of the invention are not necessarily so limited and that the first input member may instead be provided as a relay, a contact, a switch, or any other suitable type of user input member.

The security switch (or second input member) 36 of the attendant control system (or personal mobility vehicle controller) 22 may comprise any suitable type of switch or button and is connected to the housing. The security switch 36 is suitably located on the housing such that a user can operate the security switch with a finger of the hand holding the attendant control system. The security switch 36 is configured to act as a dead man switch for the personal mobility vehicle. For example, according to some embodiments of the invention, in order to perform any command with the attendant control system 22, the security switch 36 has to be closed (or pressed). However, in other embodiments of the invention, in order to perform some of the commands (such as one or more of the commands) with the attendant control system 22, the security switch 36 has to be closed (or pressed).

According to some embodiments of the invention, the different modes or profiles of the personal mobility vehicle can be changed while the security switch is depressed. However, in alternate embodiments, the mode or profile of the personal mobility vehicle can only be changed when the security switch 36 is open (or released).

According to some examples of the invention, the security switch (or dead man switch) 36 is required to be depressed in order to start motive power to the drive wheels. Additionally, the security switch 36 would need to remain depressed in order to continuously provide motive power to the drive wheels. For example, if a user is driving the chair and then releases the security switch 36, the chair would come to a stop. In particular, the use of the second input member 36 provides a security switch (or a security function) for the directional switch 38, wherein in the example above, if the user is driving the chair by manipulating the directional switch 38 and then releases the security switch 36, the chair would come to a stop. It should further be noted that features other than driving features that are operated by the directional switch 38 may also be stopped or deactivated when the security switch 36 is released.

While examples of the invention have been described in connection with the second input member 36 provided as a switch, one skilled in the art will appreciate that examples of the invention are not necessarily so limited and that the second input member may instead be provided as a relay, a contact, a button, or any other suitable type of user input member.

The directional switch (or joystick) 38 of the attendant control system (or personal mobility vehicle controller) 22 may comprise any suitable type of switch (such as a proportional input or switch input comprised of four separate switches, or a four direction/directional switch, for example) or joystick and is connected to the housing. The directional switch 38 is suitably located on the housing such that a user can operate the directional switch with a finger (such as a thumb, for example) of the hand holding the attendant control system. The directional switch 38 is configured to drive the chair, navigate through the different seat functions, activate a seat function, and/or navigate in the auxiliary menu of the auxiliary mode or profile.

It should be noted that although descriptions of the exemplary embodiments of the invention are in connection with the attendant control system (or personal mobility vehicle controller) 22 being used by a person assisting the wheelchair user (such as a caregiver, for example), one skilled in the art will appreciate that various exemplary embodiments are not necessarily so limited and that the attendant control, system (or personal mobility vehicle controller) 22 can be used by persons other than those assisting the wheelchair user, such as the wheelchair user himself/herself.

The attendant control (or personal mobility vehicle controller) 22 can be wired directly to the wheelchair control system 24 or connected wirelessly utilizing the wheelchairs available wireless protocol (such as through the wireless interface 30, for example). Additionally, the device can be removable or rigidly mounted to the wheelchair.

Exemplary embodiments of the invention provide an attendant control system enabling easier operation and usage when compared to conventional configurations. Many of the conventional wheelchairs have attendant controls that are mounted to the wheelchair with brackets that allow them to be removed for driving purposes. This is generally necessary as a rigidly mounted attendant control can be very difficult to operate. For example, the rear of the wheelchair moves opposite the direction of the front as it pivots on its drive wheels. This causes (in conventional configurations) a right joystick deflection to move the rigidly mounted attendant control in the left direction making steering difficult while requiring the attendant to stand directly behind the wheelchair. This renders the attendant (such as a caregiver, for example) unable to provide any additional assistance to the wheelchair user.

Although the conventional removable attendant controls are far easier to use for driving purposes, the conventional configurations still require use of both hands to operate the conventional attendant control. This is because one hand must stabilize the device and the other must manipulate the joystick position to control the speed and direction of the wheelchair. This adds complexity when attempting to open doors or assist the wheelchair user while operating the attendant control.

According to various exemplary embodiments of the invention, the single-handed attendant control 22 may comprise a switched or proportional input that can be directionally manipulated with a single finger or thumb while being held in the same hand. Exemplary embodiments of the invention also feature a “trigger” (or button/switch) that can prevent accidental activation and allow the caregiver (or user) to quickly change from driving the chair to assisting the wheelchair user simply by releasing the trigger.

Note that various modifications and adaptations of the foregoing exemplary embodiments of this invention may become apparent to those skilled in the relevant arts in view of the foregoing description, when read in conjunction with the accompanying drawings and the appended claims. As but some examples, the use of the exemplary embodiments of this invention is not limited to wheelchairs, but could encompass other types of mobility systems.

Further, the user interface of the wheelchair system 10 may be implemented at least in part using voice recognition technology to enter user information and commands, and an acoustic transducer may present synthesized speech to the user, as opposed to the use of a visual display. That is, the technical specifics of the user input/output may vary widely depending on the physical capabilities of the user, and any suitable type of user input/output biometric means may be employed to implement the exemplary embodiments of this invention. In general, wirelessly transmitting information from the personal mobility vehicle system 10 can occur in response to a command from a user of the personal mobility vehicle, where the command is entered via at least one of a user interface that comprises a manual interface such as a touch screen interface; a user interface that comprises reception and interpretation of user-generated biometric signals; or a user interface that comprises a user voice transducer in combination with a voice recognition function.

However, all such and similar modifications of the teachings of this invention will still fall within the scope of the embodiments of this invention.

Furthermore, some of the features of the preferred embodiments of this invention may be used to advantage without the corresponding use of other features. As such, the foregoing description should be considered as merely illustrative of the principles, teachings and embodiments of this invention, and not in limitation thereof.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. A personal mobility vehicle controller, comprising a housing having a first input member, a second input member, and a third input member, wherein the first input member is configured to change a mode or profile of a personal mobility vehicle, wherein the second input member is configured to provide a security function for the third input member, wherein the third input member is configured to operate a feature based on the mode or profile;
wherein the housing is adapted to be held in a single hand of a user, and wherein the personal mobility vehicle controller is configured to operate the personal mobility vehicle with the single hand from a location proximate the personal mobility vehicle.

2. The personal mobility vehicle controller of claim 1 wherein the mode or profile corresponds to a driving feature, a seat function feature, and/or an auxiliary function feature of the personal mobility vehicle.

3. The personal mobility vehicle controller of claim 1 wherein the first input member, the second input member, and the third input member are adapted to be operable or actuatable with the single hand of the user.

4. The personal mobility vehicle controller of claim 1 wherein the first input member comprises a button, a switch, a relay, or a contact, and wherein the second input member comprises a button, a switch, a relay, or a contact.

5. The personal mobility vehicle controller of claim 1 wherein the third input member comprises a proportional input or a switch input having four separate switches.

6. The personal mobility vehicle controller of claim 1 wherein the third input member comprises a four directional switch or a joystick.

7. The personal mobility vehicle controller of claim 1 wherein the personal mobility vehicle controller is configured to be connected to a control unit having a data processor.

8. A personal mobility vehicle, comprising:
a user-actuated hand control system; and
a personal mobility vehicle controller as in claim 1, wherein the personal mobility vehicle controller comprises an attendant control system.

9. A personal mobility vehicle, comprising:
a control unit having at least one data processor; and
a personal mobility vehicle controller connected to the control unit, wherein the personal mobility vehicle controller comprises a housing having a first input member, a second input member, and a third input member, the first input member is configured to change a mode or profile of a personal mobility vehicle, the second input member is configured to enable operation of the third input member, and wherein the third input member is configured to operate a feature based on the mode or profile,
wherein the housing is adapted to be held in a single hand of a user, and wherein the first input member, the second input member, and the third input member are adapted to be operable with the single hand of the user.

10. The personal mobility vehicle of claim 9 wherein personal mobility vehicle comprises a wheelchair.

11. The personal mobility vehicle of claim 9 wherein the personal mobility vehicle controller is an attendant control.

12. The personal mobility vehicle of claim 9 wherein the second input member comprises a security switch or a dead man switch.

13. The personal mobility vehicle of claim 9 wherein the control unit is configured to terminate operation of the feature when the second input member is released.

14. The personal mobility vehicle of claim 9 wherein the personal mobility vehicle controller is directly connected to the personal mobility vehicle.

15. The personal mobility vehicle of claim 9 wherein the personal mobility vehicle controller is connected to the personal mobility vehicle via a wireless connection.

16. The personal mobility vehicle of claim 9 wherein the mode or profile corresponds to a driving feature, a seat function feature, and/or an auxiliary function feature of the personal mobility vehicle.

17. A method comprising:
providing a personal mobility vehicle controller comprising a housing; and
providing a first input member, a second input member, and a third input member on the housing;
wherein the third input member is configured to operate a feature of the personal mobility vehicle, wherein the third input member is configured to operate the feature only when the second input member is depressed, and wherein the housing is adapted to be held in a single hand of a user.

18. The method of claim 17 wherein the first input member is configured to change a mode or profile of a personal mobility vehicle.

19. The method of claim 17 wherein a control unit is adapted to terminate the operation of the feature when the second input member is released.

20. The method of claim 17 wherein the mode or profile corresponds to a driving feature, a seat function feature, and/or an auxiliary function feature of the personal mobility vehicle.
